(19) United States
(12) Patent Application Publication
(10) Pub. No.: US 2013/0109249 A1
(43) Pub. Date: May 2, 2013

(54) Solar Grounding Spring

(71) Applicant: Jeffrey David Roth, Boise, ID (US)

(72) Inventor: Jeffrey David Roth, Boise, ID (US)

(73) Assignee: Jeffrey David Roth, Boise, ID (US)

(21) Appl. No.: 13/568,615

(22) Filed: Aug. 7, 2012

Related U.S. Application Data
(60) Provisional application No. 61/553,213, filed on Oct. 30, 2011.

(51) Int. Cl. H01R 4/48

(52) U.S. Cl. 439/816

(57) ABSTRACT

An improved method for bonding opposing parallel and perpendicular positioned electrically conductive frames or surfaces. An electrically conductive spring body formed and positioned in such a way as to provide opposing outward force to electrically adjoin the conductive frames or surfaces. The spring comprises outward facing surface penetrating contacts and surface retention springs that provide the electrical interface and positive capture of the spring to the conductive frames or surfaces. The spring can comprise a formed feature at the bottom tip of the device to capture a separate cable when the spring's tip is not being used for grounding to another surface.

This application claims priority from the PROVISIONAL APPLICATION Ser. No. 61/553,213 which was filed Oct. 30, 2011 titled, “grounding spring” by Jeffrey David Roth.

### TITLE

Solar Grounding Spring

### BACKGROUND OF THE INVENTION

Solar modules often require electrical paths to ground (earth) to prevent equipment damage under lightning strikes and also to ensure public safety. Various connection devices are available to establish electrical contact between metal frames. Solar modules themselves are photovoltaic devices that convert solar radiation from the sun into electrical energy. Each solar module comprises a plurality of solar cells typically connected in series within a module frame. A plurality of modules may be connected together to form a solar panel array. The modules are typically positioned side by side and row to row on standard and repeated interval based on standard industry racking hardware. Typically, the aluminum solar module frames have a 0.001″ anodize surface to help protect them from environmental conditions. The current method for providing the electrical ground connection between solar modules involves securing wires or surface penetrating washers to the parallel module frames with hardware such as nuts, bolts, lugs and surface penetrating washers (ie. flat or star washer). One typical frame to frame connection requires two nuts, two bolts, two lugs and two washers and a section of ground wire. Each single frame will typically have an aperture in it or some clamping connection point that will use a nut, bolt, lug and washer to provide clamping pressure between the frame surface and the washers when the nut, bolt, lug and washer are all secured and tightened together to the frames. A separate section of wire is then drawn between these clamped connection points (frame to frame) and clamped together with the same or more nuts, bolts, lugs or connecting hardware.

Another typical frame to frame connection requires two racking nuts, two racking bolts, module/frame racking clamps and two surface penetrating bonding washers. The two surface penetrating bonding washers are positioned under the module frames (between the module frame and racking) and the two racking nuts and two racking bolts are then tightened with their frame clamping hardware to the solar module frames thusly providing the necessary clamping action to secure the bonding washers as well as secure the solar module to the rack.

These connection solutions and related clamping actions will typically have required torque ratings for applying the nuts, bolts and washers together to the frames. The clamping action should provide a secure, low resistance ground connection between the frames. If the clamping action is not uniform in terms of the torque action or the washers are not positioned correctly under the frames or around the holes in the frame, a non-optimal electrical connection can result. They can also work their way loose, even when using proper torque values during initial assembly. The temperatures experienced by a solar panel can vary significantly, not only from day to night and seasonal climate changes, but also as clouds block solar energy from the sun. The repeated differential thermal expansion among the screw, the wire, the washer and the lug can cause the stresses among these parts to be relieved. Over a period of time, if sufficient movement occurs, the electrical contact can become intermittent or can cease to exist.

What is needed is a simple and easy to apply frame to frame connection that does not need the potentially unreliable and time consuming application of nuts, bolts, washers and wires and that also permits rapid and reliable solar array assembly under varying environmental conditions and varying frame heights and varying frame to frame spacing.

### SUMMARY OF THE INVENTION

The solar grounding spring comprises an electrically conductive body formed and positioned in such a way as to provide opposing outward force to electrically adjoin separate parallel and perpendicular conductive frames or surfaces. The spring comprises outward facing surface penetrating contacts on the spring's vertical and horizontal conductive body surfaces that provides the electrical connecting interface to the separate parallel and perpendicular electrically conductive frames or surfaces. The spring comprises surface retention springs on the conductive body surface that compress during installation and then spring outward once reaching the bottom of the separate parallel and perpendicular conductive frames or surfaces thusly positively capturing the spring to the underside of the separate parallel and perpendicular conductive frames or surfaces. The surface retention springs are positioned width-wise and length-wise on the vertical spring elements providing a field of multiple connection points to the separate parallel and perpendicular conductive frames. The vertically positioned surface retention springs provide positive capture for varying heights of the separate parallel and perpendicular conductive frames or surfaces. The solar grounding spring comprises two top horizontal spring members generally perpendicular but at acute downward angle to the opposing spaced apart vertical spring elements. The two top horizontal spring members provide upward force and bias so as to engage the bottom surface springs thereby providing positive topside and underside capture of the separate parallel and perpendicular conductive frames or surfaces. The solar grounding spring can comprise a formed feature at the bottom tip of the device to capture the solar panel's interconnecting cable when the tip is not being used for grounding to the rack.

An advantage of the solar grounding spring is the removal of time consuming labor operations using known methods of assembling and grounding two solar panels or an array of panels. Specifically, the time consuming tasks of 1) connecting the washer, nut, and bolt of the ground lug to the solar panel's conductive frames or surfaces, 2) torque tightening the washer, nut, and bolt of the ground lug to the solar panel's conductive frames or surfaces, 3) inserting the separate ground wire into the then installed ground lug and 4) clamping the lug actuator or hardware to the ground wire.

Another advantage of the solar grounding spring is that it can be very easily removed and replaced.

Another advantage of the solar grounding spring is that the formed cable feature at the bottom of the device can integrate that typically separate function into this single spring design.

Other features and advantages of the solar grounding spring will be apparent from the following more detailed description of various embodiments, taken in conjunction with the accompanying drawings which illustrate, by way of example, the principles of the invention.

### BRIEF DESCRIPTION OF THE DRAWINGS

FIG. 1 is a perspective view of a grounding spring of one embodiment in a closed but uninstalled position.

FIG. 2 is a perspective view of a grounding spring of one embodiment in an installed position.

FIG. 3 is a perspective view of one possible “sawing” style contact geometry.

FIG. 4 is a perspective view of one embodiment of “slicing” style contact geometry.

FIG. 5 is a perspective view of one embodiment of “slicing” style contact geometry.

FIG. 6 is a perspective view of one embodiment of “slicing” style contact geometry.

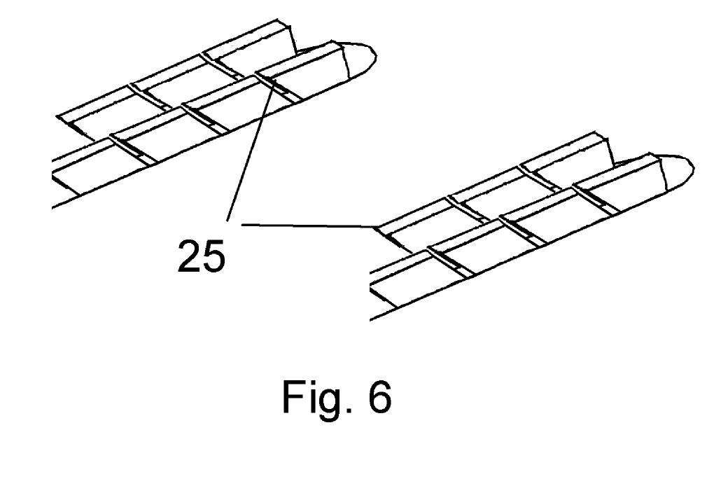

FIG. 7 is a perspective view of prior art.

FIG. 8 is a perspective view of a grounding spring of one embodiment that provides and additional electrical contact on the tip for a perpendicular surface plane.

FIG. 9 is a perspective view of prior art.

FIG. 10 is a perspective view of prior art.

### DETAILED DESCRIPTION OF THE INVENTION

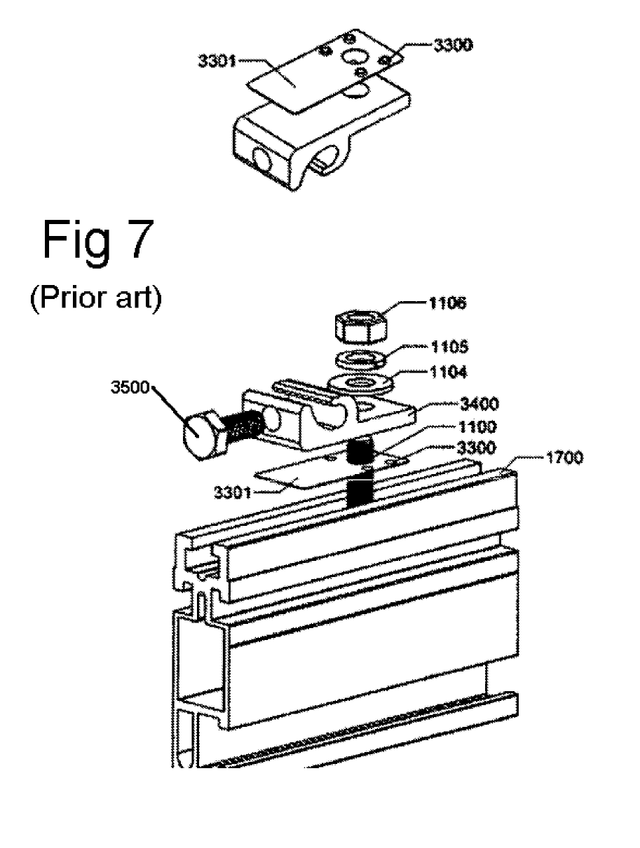

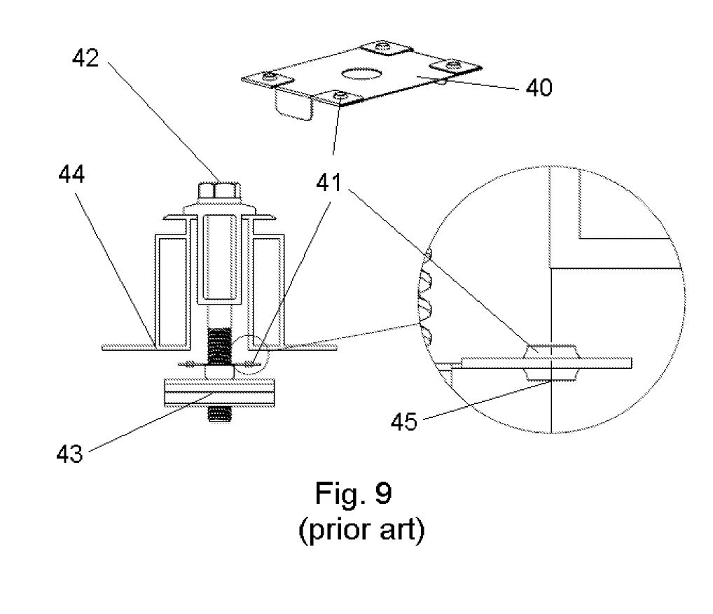

FIG. 7 and FIG. 9 illustrates features of prior art from authors Brian Thomas Wiley, Palvin Chee Leong Chan, patent U.S. Pat. No. 8,092,129 dated Jan. 10, 2012. The washer 3301 and 40 are formed from a flat metal piece and have four surface penetrating upward and downward facing circular rings 3300 and 41 that are used to penetrate the solar frame anodize. FIG. 7 shows how the washer is assembled and clamped to the solar frame assembly with a ground lug 3400, nut 1106, bolt 1100, and two additional washers 1104 and 1105. Once assembled to the solar frame assembly, a cable is then inserted into the ground lug and the clamping screw 3500 is tightened down onto it. This is repeated for each solar module. FIG. 9 shows how the washer 40 is assembled and clamped between the module frame 44 and racking 43 using the module mounting hardware, nuts (recessed in the rack 43), and bolts 42. Each of these figures shows the hardware and related torque dependencies necessary to secure these washers in the applications. In addition, FIG. 9 shows one possible fifty percent misalignment potential of the washer 45 that can result in a less than optimal electrical connection. In the case of the FIG. 9 application, each solar module requires two of the washers 40 be applied to each mounting clamp set thusly duplicating the cost, hardware, torque requirements and related risks for each solar module. Also, typically, each set of racking hardware has its own unique hardware dimensions and related tolerances that set the solar modules at slightly differing spacing between the module frames thusly requiring differing dimensioned washers for each rack application. This dimensional complexity can sometimes result in the wrong washers being selected and applied for a given racking application. This approach also lends itself to possible accumulated tolerance misalignments between the various washers and various racking hardware components that provide the alignment. Also, in the case of FIG. 7, the repeated differential thermal expansion among the nuts, bolts, washers, and lugs typical in solar applications can cause the stresses among these parts to be relieved. Over a period of time, if sufficient movement occurs, the electrical contact can become intermittent or can cease to exist. Lastly, in the case of FIG. 9, typically the washer location is not visible to the module installer once installed. If for any reason the installer of the solar modules forgets to install the washer, the affected solar modules have to be located and completely removed so that the washers can be installed and then the modules replaced and re-secured onto the racks.

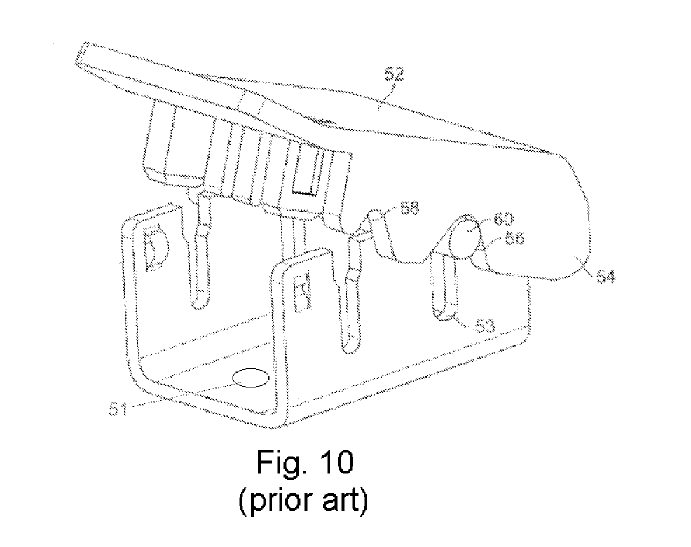

FIG. 10 illustrates features of prior art from author Stephen D. Gherardini, U.S. Pat. No. 7,195,513 dated Mar. 27, 2007. This grounding connector typically uses a similar method of nut, bolt, and surface penetrating washer attachment to secure it to the solar module frame. This approach requires an aperture in the solar module frame. The aperture on the connector 51 is positioned over the solar module frame's aperture and then the required nut, bolt, and surface penetrating washer are then tightened to a necessary torque level. Once the connector is secured to the solar module frame, a separate grounding wire 60 is then dressed into the slot 53 of the connector and then the “stuffer” housing 54 is pushed down to secure the wire into the slot and make electrical contact between the wire and the solar module frame. This process is repeated for each solar module. This figure illustrates the time consuming and costly hardware and related torque dependency necessary to secure this connector and cable to the solar module frame. In addition, if the aperture of the solar module frame is too large for the required surface penetrating washer of the connector, misalignment of the washer can occur and a less than optimal electrical connection can result. Lastly, as described earlier, the repeated differential thermal expansion among nut, bolt, washer, and the connector typical in solar applications can cause the stresses among these parts to be relieved. Over a period of time, if sufficient movement occurs, the electrical contact can become intermittent or can cease to exist.

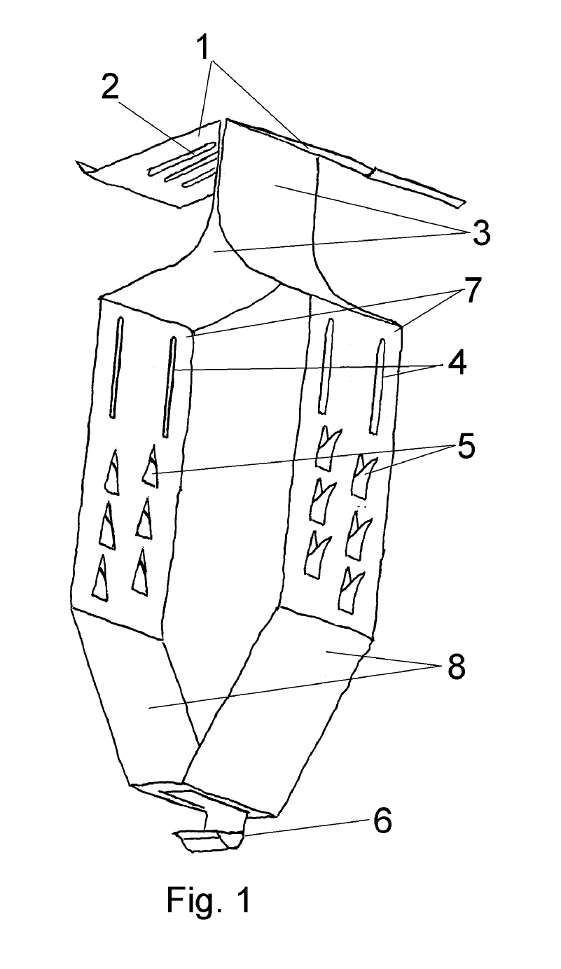

The solar grounding spring is depicted in FIG. 1 in a closed but uninstalled position. In this embodiment, the solar grounding spring is a stamped and formed single piece metal part made with either a progressive metal forming die or a series of separate metal forming dies and related metal forming operations. The solar grounding spring comprises two top horizontal conductive spring members 1 incorporating a plurality of downward facing surface penetrating slots or contacts 2, two top vertically curved spring members 3, two side vertical conductive members 7 incorporating a plurality of outward facing surface penetrating slots or contacts 4 as well as a plurality of surface retention springs 5, two bottom vertically angled spring members 8 and an integral curved cable clip on the bottom horizontal tip of the device 6. Typically the solar grounding spring will be .020″ thick by 1″ wide stainless steel and a single spring can establish a good electrical contact when properly inserted between two solar module frames. The solar grounding spring can be applied at any time after the solar modules have been secured to the racks and are easily visible to the installer once installed. These are two of the ground springs advantages.

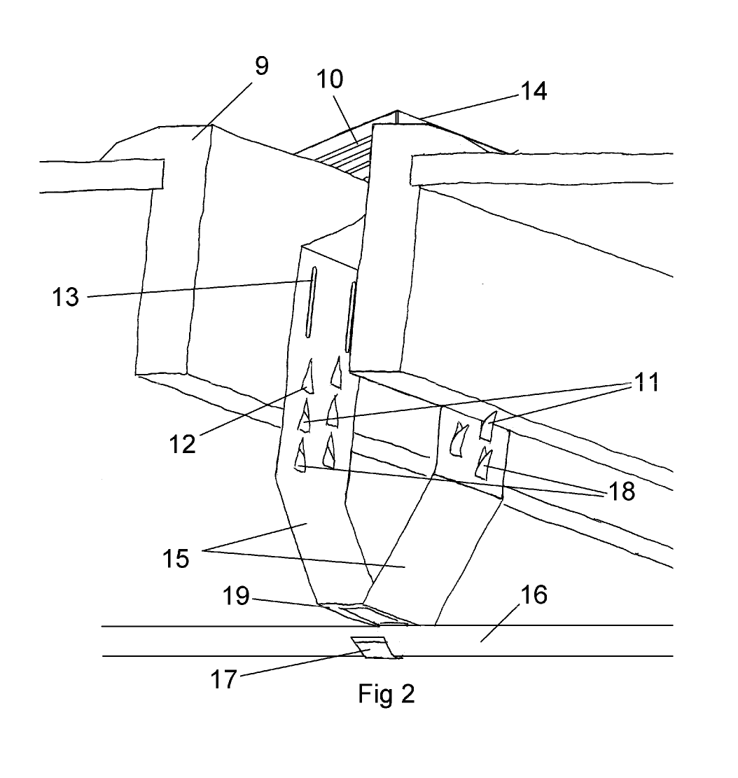

FIG. 1 and FIG. 2 shows the solar grounding spring in the installed position. In this embodiment, the overall operating width of the opposing vertical conductive members 7 of the solar grounding spring will be greater than the installed width between the solar modules they are to electrically bond together. The vertical spring members 15 and 3 provide inward flexure and travel thusly enabling the solar grounding spring to work with varying widths between the solar modules 9 they are intended to electrically bond together. The opposing width of the two side vertical conductive members 7 created by the vertical spring members 15 and 3 can be increased or decreased during manufacturing to increase or decrease the functional operating width of the solar grounding spring. For example, the one embodiment of the solar ground spring could accommodate a typically wide range of solar module spacing of 0.75″ to 1.25″ whereas a narrower manufactured ground spring could accommodate 0.25″ to 0.50″ solar module spacing. This range of operating width would provide constant and uniform outward force of the solar ground spring to the solar module frames and offer dimensional travel and compliance during its operational life and under varying hardware tolerances. This could also allow it to maintain, and in some cases, improve the electrical bond as the solar module frames physically adjust and shift position during thermal cycling. This is one of the solar grounding spring's advantages.

Referring to FIG. 1 and FIG. 2, the bottom vertical spring members 15 are tapered inward and downward starting from the bottom edges of the two side vertical conductive members and ending at either side of the bottom tip 19. The angled taper of the bottom vertical spring members provide the closure, positioning and alignment for the insertion of the solar grounding spring into the evenly spaced solar modules. As the solar ground spring is inserted, the taper eventually becomes larger than the spacing between the solar modules and the vertical spring members 3 and 15 start to become compressed thusly providing the outward force necessary for the grounding spring to function.

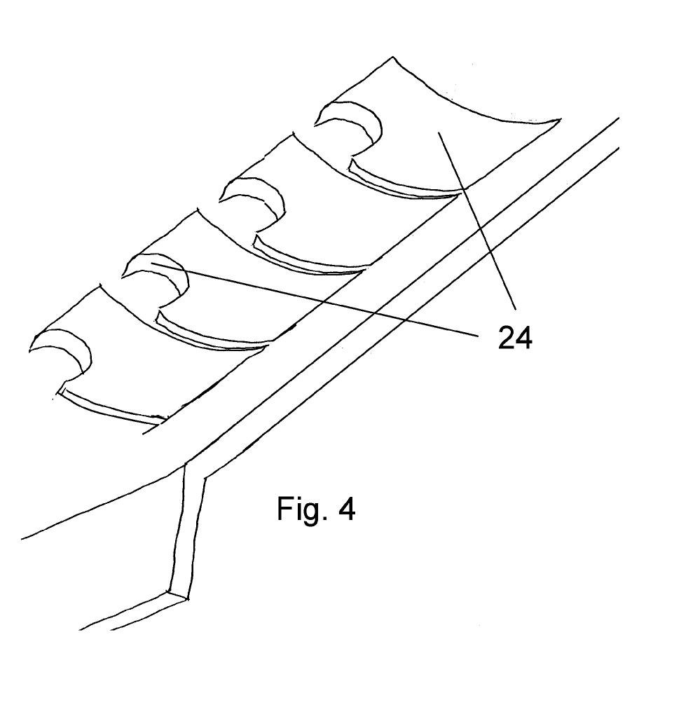

Referring to FIG. 1, the solar grounding spring has a plurality of contacts and contact surfaces 2 and 4. In one embodiment, in the case of the two side vertical conductive members 7, the contacts are comprised within two vertical slots 4 on each member with outwardly formed surface penetrating contacts on each side of the vertical slot. This provides four sets of contact columns on each vertical member of the solar grounding spring. As shown in FIG. 4, each vertical contact column has formed gaps within the contact slots that create four independently functioning contact points 24. Each independently functioning contact has a formed edge that faces downward which provides the surface penetrating piercing and cutting action necessary to penetrate the anodize.

In one embodiment, in the case of the two top horizontal springs 1, the contacts are comprised within three sets of horizontal slots 2 on each horizontal spring member with downwardly formed surface penetrating contacts on each side of the horizontal slot. This provides six sets of contact columns on each horizontal spring member of the solar grounding spring. As shown in FIG. 4, each horizontal contact column has formed gaps within the contact slots that create four independently functioning contacts 24. Each independently functioning contact has a formed edge that faces downward which provides the surface penetrating piercing and cutting action necessary to penetrate the anodize.

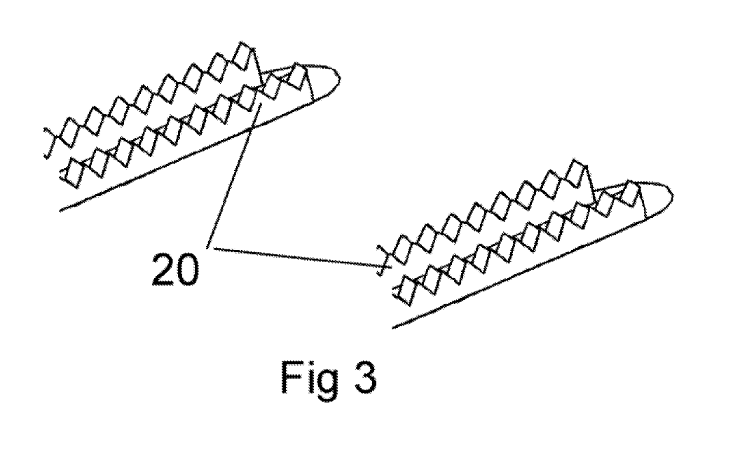

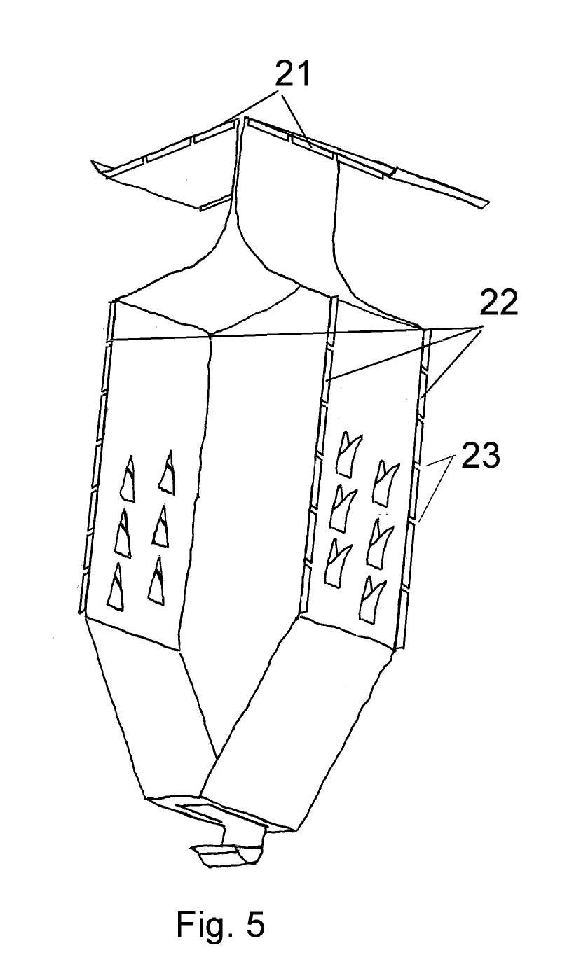

Referring to FIG. 1, depending on the surface of the electrically conductive frames to be bonded together, the contacts positioned on the top horizontal springs 2 and two side conductive members 4 could take a myriad of forms, shapes and geometries ranging from just a flat contact-less “smooth” metal surface for uncoated metallic frame surfaces, to a surface penetrating “sawtooth” cutting contact design FIG. 3, 20 to a surface penetrating “slicing” design like that depicted in FIG. 4, 24. The surface penetrating contacts would typically have to penetrate the 0.001″ thick anodize present on the typical solar module frame. As shown in the embodiment of FIG. 1 and FIG. 5, the myriad of contact shapes and geometries could be positioned on the top horizontal springs 2 and two side conductive members 4 in a myriad of possible locations on those surfaces. For example, in the case of FIG. 5, the contacts and contact surfaces 21 and 22 are positioned on the outside edges of the top horizontal springs and two side conductive members of the solar ground spring. These contact surfaces are separated by small gaps 23 to create individual spring members and contacts that face downward 25. Thus, it should be clear to those skilled in the art that the specific contact quantity, style, geometry and arrangement could be varied to accomplish the necessary electrical connection for the specific parallel and perpendicular electrically conductive surface application.

As shown in FIG. 1 and FIG. 2, the plurality of surface retention springs 5 are typically positioned in vertical columns on the solar ground spring's vertical conductive member. These surface retention springs compress inward 12 as the solar ground spring is inserted between the solar module frames 9 and then flex outward 11 as they pass the bottom edge of the solar module frames thusly positively capturing the solar ground spring to the underside of the solar module frames 9 and inhibiting the spring's removal. The columns of surface retention springs allow the solar grounding spring to be used with varying heights of solar module frames 9. For example, FIG. 2 shows the positive capture of the surface retention springs 11 on one possible height of solar module frame whereas a deeper solar module frame height could require the bottom surface retention springs 18 to secure the solar ground spring to their solar module frames. This varying height registration and related positive capture is one of the advantages of the solar grounding spring.

Referring again to FIG. 1 and FIG. 2, the top horizontal spring members 1 have an acute downward angle relative to the top horizontal plane of the solar modules. These top horizontal spring members provide the pushing surface to insert the solar grounding spring, positive capture to the top of the solar module frames as well as provide upward force and bias as they are compressed towards a perpendicular angle to the vertical edges of the module frames 9 during installation. That upward force and bias is transferred to the surface springs 11 that are captured on the underside of solar module frames. The upward force and bias and positive capture of the top of the module frames provided by the compressed top horizontal spring members 1 in conjunction with the positive underside capture of the surface springs 11 to the underside of the module frames inhibit the spring's removal.

As can be seen in FIG. 2, typically the bottom vertical spring members 15 can be gripped by hand or pliers and squeezed together thusly releasing the surface retention springs 11 from the solar module frames and allowing the solar grounding spring to be vertically removed from the solar module frames it is adjoining. This ease of removal is one of the advantages of the solar grounding spring.

In the embodiment shown in FIG. 2, the solar ground spring could have an integral cable clip 17 formed at its tip. This cable clip would allow the capture of the solar module's interconnecting cable 16. In one embodiment, this integral cable clip would be designed to accommodate the varying diameters of industry solar cable it is to capture. This integral cable clip is one of the advantages of the solar grounding spring. It would save additional time and labor during the installation process.

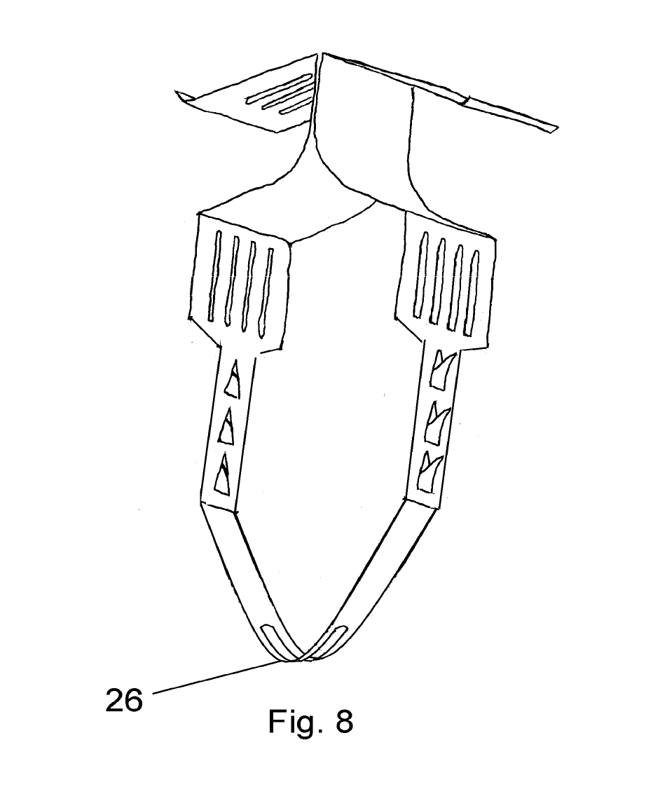

In the embodiment shown in FIG. 3 and FIG. 8, the solar ground spring could have the bottom tip formed with surface contacts 26 and 20 that could provide electrical connection to a bottom perpendicular conductive surface as well. For example, as shown in FIG. 7, the top of the rack 1700 that the solar module sits on can have a U-shaped channel that the ground spring FIG. 8 could enter as it's applied between the solar modules. The ground spring tip and contact 26 could enter that channel and make electrical contact 26 and 20 at the bottom of the channel thusly electrically connecting the solar module frames to the rack.

To apply the solar grounding spring, the user grips the top horizontal spring members between their thumbs and forefingers and brings the top two vertically curved spring members 3 together. The user then inserts the bottom tip 19 of the solar grounding spring into the gap between the solar modules and then pushes downward until the part has compressed at least one set of the retention teeth 18 on each side thereby physically squeezing and temporarily securing the ground spring between the two solar module frames. Then, with the heel of one of their hands applied to the top surface of the horizontal conductive spring members 1, the user pushes the solar ground spring downward until the top horizontal conductive spring members 1 are compressed and are approaching a perpendicular plane to the vertical edges of the solar module frames. The part is now positively secured to the solar module frames providing electrical ground without any other external nuts, bolts, and washer hardware dependencies, as well as, no installation hardware placement and torque tightening dependencies.

### CONCLUSIONS, RAMIFICATIONS AND SCOPE

Thus the reader will see that at least one embodiment of the solar grounding spring provides several advantages such as 1) the reduction of time consuming labor operations using currently known methods of assembling and grounding of solar panels or arrays of panels 2) more easily and faster removal and replacement if necessary, 3) allows for additional material and labor cost savings through the integration of the cable retention feature into the bottom tip of the device, 4) assembly flexibility in that it can be applied at any time after the solar modules have been secured to the racks, 5) it is easily visible to the installer once installed, 6) the flexible application operating width range and related constant outward force provides dimensional travel and compliance during its operational life and 7) the positive capture and registration under varying module heights.

While my description refers to one possible embodiment, it will be understood by those skilled in the art that various changes may be made and equivalents may be substituted for elements thereof without departing from the scope of the invention.

In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed

1) a spring for use with, but not limited to, two photovoltaic module assemblies which comprise opposing parallel and perpendicular positioned electrically conductive frames or surfaces: The spring comprising:
An electrically conductive body formed and positioned in such a way as to provide opposing outward force to electrically adjoin the separate parallel and perpendicular electrically conductive frames or surfaces. A surface penetrating contact or contacts on the spring's conductive body surface that provides the electrical connecting interface to the separate parallel and perpendicular electrically conductive frames or surfaces.

2) The spring according to claim 1, wherein the surface penetrating contact or contacts are formed and positioned to grip the top and sides of the separate parallel and perpendicular electrically conductive frames or surfaces thusly inhibiting the spring's removal.

3) The spring according to claim 1, wherein surface retention springs on the two side vertical conductive members can be formed and positioned at an acute upward angle to the bottom edge(s) of the separate parallel and perpendicular electrically conductive frames or surfaces so as to provide positive capture and inhibiting the solar grounding spring's removal.

4) The spring according to claim 3, wherein the surface retention springs are positioned width-wise and length-wise on the two side vertical conductive members and provide positive capture of the solar grounding spring under varying heights of the separate parallel and perpendicular conductive frames or surfaces.

5) The spring according to claim 1, wherein the top is formed in such a way as to provide positive capture of the top of the separate parallel and perpendicular electrically conductive frames or surfaces.

6) The spring according to claim 1, wherein the top is formed in such a way as to provide pulling upward interactive spring force on the bottom positive capture feature detailed in claim 3.

7) The spring according to claim 1, further comprising a variety of surface penetrating contact shapes and geometries.

8) The spring according to claim 1, wherein the conductive spring body can be a single conductive metal form or can be captured within another housing, material or form.

9) The spring according to claim 1, wherein the surface penetrating contact shapes and geometries can come in a variety of lengths, heights and widths.

10) The spring according to claim 1, wherein the spring can have an integral feature to capture and secure a separate cable.

11) The spring according to claim 10, wherein the integral feature can accommodate varying diameters of cable.

12) The spring according to claim 1, wherein the two top horizontal spring members come together to create a pushing surface for insertion.

13) The spring according to claim 1, wherein, after installation, the bottom vertically angled springs can be squeezed together for easy removal.

14) The spring according to claim 1, wherein the bottom tip could have surface contacts that could provide electrical connection to a bottom perpendicular conductive frame or surface.
